(19) United States
(12) Patent Application Publication
(10) Pub. No.: US 2009/0125325 A1
(43) Pub. Date: May 14, 2009

(54) MEDICAL EQUIPMENT ALLOCATION AND UTILIZATION SYSTEM AND METHOD

(75) Inventors: Pedro Martinez, Boca Raton, FL (US); Noel J. Guillama, Wellington, FL (US); Chester Heath, Boca Raton, FL (US)

Correspondence Address: COZEN O'CONNOR, P.C., 1900 MARKET STREET, PHILADELPHIA, PA, 19103-3508, US

(73) Assignee: THE QUANTUM GROUP, INC., WELLINGTON, FL (US)

(21) Appl. No.: 12/266,240

(22) Filed: Nov. 6, 2008

Related U.S. Application Data
(60) Provisional application No. 60/986,652, filed on Nov. 9, 2007.

(51) Int. Cl. G06Q 50/00

(52) U.S. Cl. 705/2

(57) ABSTRACT

A data processing system for assigning patients to providers of medical services and/or equipment is disclosed. The system comprises a database of providers of medical services and equipment for patients, the database comprising records which comprise provider, medical service, medical equipment, instrumentation, location, and time slot data, means to receive a request for a medical procedure requiring a specific instrumentation for a first patient or for medical equipment, and means to return at least one time slot for the specific instrumentation for the medical procedure in response to the request.

### CROSS-REFERENCE TO RELATED APPLICATIONS

This application claims priority from provisional application 60/986,652, filed Nov. 9, 2008, which is hereby incorporated by reference.

### BACKGROUND

This invention relates to the field of healthcare equipment allocation and utilization systems, more specifically to data processing systems which aid in such allocation and utilization.

Several factors combine to complicate the efficient utilization of medical assets and skills. An aging population increases the demand for medical services yet, due to planning anomalies, scarcities and surpluses exist with medical skills, support and equipment. Medical technology advances create narrow specializations in some areas and a reduced breadth of aptitude where training has not kept pace. Haphazard investment has clustered an oversupply of equipment and services in some areas and paucity in others. In some situations, for example, in cases of natural disasters, rapid location and utilization of medical equipment and services is extremely critical. Existing systems for scheduling, location, and allocation of medical resources is very inefficient in that each piece of equipment, each medical provider and medical provider group, and each medical asset is traditionally scheduled separately.

For example, it is not uncommon for multiple competing MRI centers to go half utilized and even far less than that considered on a 24×7 schedule. Oncology infusion centers may be jammed at certain times of the day and vacant at others. A cardiac surgeon who specializes in off-pump bypass may go days without sleep due to urgencies caused by a flurry of 911 operators directing traffic to one hospital and not another while the surgeon in the other hospital may be underutilized or even idle.

MRI centers require very large investments and must show a return to justify the financial, technical and provisioned support that assembles the function. Further, there is a variation in need from the motorcycle head injury referred by a trauma center to identifying the blocked sinus that is more inconvenience than emergency. There is a variation in capacity or function where certain individuals require only an open version while others require the precision of the newest closed machine. Many situations might just as easily use either technology; whichever is most convenient in distance, time, or cost.

Each situation is different and a weighted balance of all the factors toward an optimized, “best” utilization of the equipment is the objective. Indeed, if a community is served well by proper utilization of a portion of the available equipment, then the remainder can be relocated to areas with lesser availability of the technology. An efficient and effective system and method to allocate assignment of skills and equipment and attract consumption of underutilized or off-peak assets would be very useful and desirable for not only patients but medical providers of services and equipment and insurance companies which would benefit by lowering overall costs of services and equipment. Solving the scheduling problem is not trivial and can not be accomplished by traditional manual methods.

The problem is also bound by space and time within a community, where allocation of available access is meaningful with a few hours and a few miles, but not effectively managed to orders of magnitude more. The problem becomes more complex as boundaries of adjacent communities overlap and a resource made critical in one community is freed by cascading an availability (or time slot) from an adjacent community by juggling multiple situations within both communities.

What is needed is a dynamic and intelligent system that will search for, identify and coordinate greater usage of these medical services and equipment, across geographic boundaries, time, and multiple practices and providers, using real-time information to link patients to desired instrumentation, medical equipment time slots, and/or durable medical equipment, and to efficiently and quickly allocate medical services or reasonable alternatives in triage scenarios.

### SUMMARY OF THE INVENTION

It is an object of this invention that all medical resources, for example MRI, cardiac surgeons, dialysis apparatus, and psychiatric nurse practitioners, should be allocated to their highest and best use with particular emphasis where human life and safety are in the balance. The measurements of productivity will in some cases be profit, in others “percent utilization,” and in others “lives saved” or made more comfortable. The usage of complex and expensive medical instrumentation (i.e. CAT scan, PET scan, sonogram, and the like) is sub-optimized by the healthcare industry. When large capital investments are less then fully utilized, the result is higher cost of operation.

The present invention is directed to allocating medical resources intelligently and efficiently across and amongst a plurality of alternatives. The invention comprises in one aspect a data processing system for assigning patients to providers of medical services, prosthetics, treatment, care, durable medical and/or diagnostic equipment, comprising a database of providers of medical services and equipment for patients. The database comprising records and metadata surrounding past care and procedures which comprise provider, medical service, medical equipment, instrumentation, location, and time slot data, means to receive a request for a medical procedure requiring a specific instrumentation for a first patient or for medical equipment, and means to return at least one time slot for the specific instrumentation for the medical procedure in response to the request. Metadata might include the history of timeliness of a patient to past appointments, suitability or reliability of equipment to a given procedure, or degree of experience and training by a given provider. Such data may be collected as a procedural artifact of past experience, mined from records, or come as a result of various survey and quality control procedures.

In another aspect the invention comprises a method for assigning patients to providers of medical services and/or equipment comprising sending a scheduling request from a client to a server system, said scheduling request including patient identification, location, requested service and/or equipment, and the like, determining whether one or more time slots are available locally or at alternative providers, if more than one time slot, or provider is available, scheduling the patient according to a predetermined formula associated with said patient identification and resource identification stored in local memory to said server system; loading an associated patient schedule and resource schedule from a database into local memory; determining available times for the resource schedule at the server system, receiving requests for medical services and/or equipment, sending a task request from a client to a server system, the task request including patient identification and resource identification; determining whether schedules associated with said patient identification and resource identification are stored in local memory to said server system; loading said associated patient schedule and resource schedule from a database into said local memory; determining available times for said resource schedule at said server system. Ideally, the concept can be extended to optimize availability of treatment across broad corporate, geographic and national boundaries making appropriate, rapid decisions relating to delay, suitability of care, skill requirements and cost.

The system is composed of redundant, highly available and scalable online Internet server resources that is architected for records security, expansion and adaptability. The system can include auction, reservation, database, and electronic marketplace software to implement the describe algorithms matching patient needs with available resources, with particular attention to scalability in times of mass need.

The invention comprises in another aspect a data processing system for assigning patients to providers of medical services and/or equipment comprising a database of providers of medical services and equipment for patients, the database comprising records which comprise provider, medical service, medical equipment, instrumentation, location, and time slot data, means to receive a request for a medical procedure requiring a specific instrumentation for a first patient or for medical equipment, and means to return at least one time slot for the specific instrumentation for the medical procedure in response to the request.

Examples of medical instrumentation which can be scheduled include CAT scan, PET scan, sonogram, open MRI, closed MRI, dialysis, diathermy, prosthetics instrument, and genetically engineered structures.

In certain embodiments the records are dynamically updated with current available time slots of each provider for each procedure using each medical instrumentation.

The system can also be used when the providers of medical services and/or equipment comprise providers of durable medical equipment.

In some embodiments the system directly bills a patient or an insurer of a patient for a diagnostic procedure and medical equipment usage provided by an assigned provider.

The system can include means to calculate trends regarding diagnostic procedures requested and assigned and/or to predict conditions of care and requirements for supporting technology and services. In such embodiments data regarding previous usage, pricing, missed appointments, insurance coverage, and/or payments is processed by the means to calculate the trends.

The system can be adapted to triage the assignment of patients to providers of medical services and/or equipment during periods of disaster or national emergency. In cases where more than one time slot is returned to the requester or client or patient, the requester, client, or patient normally will select one of the time slots and the system will automatically confirm the appointment to the requester, client, or patient and the provider.

The system in some embodiments can also price a medical procedure or equipment time based on temporal proximity between the request and the available time slots or geographical proximity between the client and the provider of services, diagnostic equipment, or durable medical equipment.

### BRIEF DESCRIPTION OF THE DRAWINGS

FIG. 1 is a representation of the sequence and flow of one embodiment of the invention.

FIG. 2 is a representation of the architecture and services provided in one embodiment of the invention.

### DETAILED DESCRIPTION

The invention comprises a data processing system configured to assign patients to providers of medical services and/or equipment. It comprises a database of providers and their schedules so that time slot availability is calculated or provided. The system is aware of the schedules of doctors, the disease and disabilities of patients, prescriptions, histories, complete medical records, lab reports, imaging and all other facets of the various medical centers that contribute to the patient's wellness.

The scheduling system can provide priority access and/or pricing based on an individual's history of timeliness with previous appointments in which case the system calculates a probability or likeliness that the patient would show up on time. Since time slots on certain very expensive medical equipment is so valuable, the system can provide insurance to cover the expenses of operating the equipment for the reserved time slot in the event of non-use at a calculated premium In the case of emergencies, the system could determine probability of use in response to trauma and reserve availability at a predicted time of need. If multiple events require reservation of more equipment than is locally available, allocation of nearby service could be according to highest and best use, with the most critical situations requiring specialized equipment receiving highest priority. For example, a multi-injury accident might reserve a MRI system for a traumatic head injury, thoracic puncture, and broken skeletal components at the time an EMT arrives at the scene. Both the head injury and puncture would be considered to be high priority and the system would reserve MRI time at the predicted time of arrival. Should either injury be determined to be of lower priority after treatment, the reserved MRI capacity would then be released to a higher priority need. Should needs exceed local capacity, patients could be routed to alternatives.

All medical services, skills, equipment and assets could be managed and scheduled by the system of the invention for highest and best use. In case of disaster, the system can act as a central service with access from any point on the Internet. This feature is intrinsically scalable to handle a major disaster such that multiple services for multiple communities could be allocated, routed and managed. The Invention could also interrogate records of patient, hospital, care provider specific skills and capacities for proper allocation of assets. Pricing for some medical services and equipment could be based on past transactions versus time to availability. Near term unallocated slots might be filled at a higher rate whereas long term time slots might be reserved at lower cost. Price might be quoted at a rate which varies with distance to service. This could place a distant service on par with one nearby, to induce equal utilization of the distant service, or provide affordable service. The pricing algorithm could be based on time of availability where the historical sales for a given time of day or day of week would predict the most likely price at which a time slot could be sold. The time slots could be sold according to competitive auction bidding where a reserve price could be entered, potentially representing the actual cost of service delivery, some minimal profit, some fraction of the cost to keep the service available, or zero. A bidding assistant module could bid for fixed price at last minute, allowing individuals to bargain hunt for the lowest price. The auto-bidding feature could span several auctions for a low price until the desired price is obtained. In some embodiments of the invention timeslots for service could be sold as bulk futures or block sales where buyer assumes the risk that they will not sell all of a block. Timeslots could be reserved or sold as a Dutch auction where a block of timeslots is bid on by multiple bidders and sale goes to top bids. In some embodiments a module which provides the ability to choose between alternative treatments, with respective time and equipment requirements—yet yielding equivalent benefit, is provided. It would be optimization of alternative choices in therapeutic procedure, which would imply alternatives in required equipment, services, timeslots. For example, a patient could be sent to St Mary's for hyperbaric treatment of a burn (procedure A) which requires a slot in the hyperbaric chamber. Alternatively, they could go to the University Hospital's wound center to be treated by Dr. Snyder using an oxygenated sponge treatment—which requires time on Dr. Snyder's calendar and a supply of the special oxygenated sponges and an air entrained recovery bed. The choice of therapy therefore depends on the combined availability of a collection of implied supplies, skills and equipment. This is the complex tradeoff of equipment versus skilled therapy providers versus critical provisions and supplies that taken to an extreme with multiple alternatives and restrictions on availability of part or all of the requirements, quickly becomes a decision that only a computer can envision.

Pricing of a reserved timeslot could be preferential based on volume where pricing goes down with periodic total sales; potentially per a published schedule. A resale broker may market released timeslot commitments on the system. Slots of associated services may be bid consecutively and conditionally. For example, a client may first bid on lab tests (a prerequisite to an MRI) until one is won, then bid on an MRI timeslot, once MRI complete, then bid on doctor consultation on interpretation of MRI results.

A credit plan can be provided to finance future or block sales to bidders using the system.

Sub-Brokering may be permitted wherein proxy sales of timeslots, services, or assets can be offered in block for future services, for example a broker may call potential users, collect individual reservations on tentative future sale and commit a block only after all individual reservations are received, wherein the operator of the system assumes the risk that not all of a block of timeslots will sell.

The system can be adapted to allocate skills in triage situations wherein skills could be allocated based on highest and best use, factoring in whether a substitute is available, or on a pro-rata basis with leveled overtime, or based on maximum utilization limit, or factoring in skills having at least minimum utilization, or based on collateral impact, or prioritizing based on whether there are communicable diseases and success probability. Services can also be allocated based on historical need, on historical payback (i.e., based on who reciprocates/returns the favor), on historical commitment (where favor is owed), and/or on basis of cost (maximum efficiency of budget). In a disaster situation, assignment of skilled teams may be coordinated by the system. The cardiac surgeon may work preferentially in a team with a given individual or set of coordinating skills. For example: anesthesiologists, heart-lung technicians, and/or nurses. A thoracic surgeon may have a team, as may a neurosurgeon whom a procedure is rehearsed and practiced most successfully. The members of the team, including equipment, assets, services (such as an operating room) may be allocated by the system as a unit. Members of one team may optionally and selectively be members of other teams. Based on historical success or failure records, the system may configure teams. In times of emergency or disaster, such teams could be defined on the fly by the system based on credentialing records and certifications of members unknown to each other.

The definition of a community is assumed bounded by the reasonable transit time of patients, skills, equipment and assets given current technology. However, with the advent of telemedicine, remote robotic surgery, portable medical units or the increased needs of a general emergency or disaster, the system can adjust the size of a community based on computed capacity. That is, the system can expand what is reasonable according to new capacities or urgency of need. The system can simulate emergencies, using the credentialing records, certifications, available technical, emergency response, military and medical resources to pre-configure teams, pre-deploy resources, plan near term training and long term education and create a general disaster recovery plan for a community of any size.

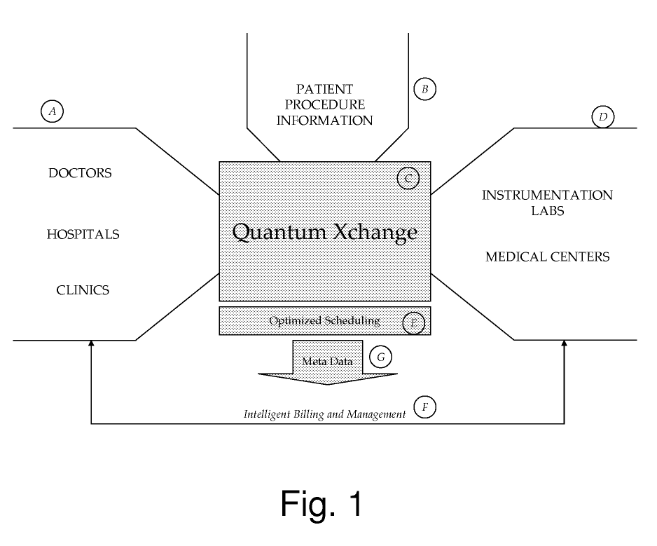

The sequence and flow of one embodiment of the system is illustrated in FIG. 1 wherein the system (C) is designated “Quantum Xchange” wherein doctors, hospitals, and clinics (A) and instrumentation labs and medical centers (D) communicate their time slot availability to the system. Patient procedure requests (B) are received at the system (C) over the internet and time slots are offered to the patient by the optimized scheduling module (E). The scheduling module may factor in metadata (G) which may include patient history of showing up for appointments on time and other factors such as compliance history and responsiveness to treatment which can be used to predict likelihood of a time slot appointment being kept by the patient, relative costs of procedures and equipment from each provider, for example. The metadata (G) can be created from the analysis of the transactions, patient information, instrumentation usage patterns and the resulting interrelationships. This information can be used to understand key trends, patient behavior, responsiveness and compliance to treatment, and predict future conditions of care and requirements for supporting technology and services.

The system can also include an intelligent billing and management module (F) which bills for a particular time slot based on variables such as relative geographic location and temporal proximity of the time slot request to the time slot selected or provided. By intelligently monitoring patient and instrumentation demands, the data processing system produces a set of optimized and recommended times and locations (E) for the patient procedure in real-time. Immediately, upon completion of the procedure at the instrumentation center, the electronic billing is initiated and reconciled (F) with the referring physician.

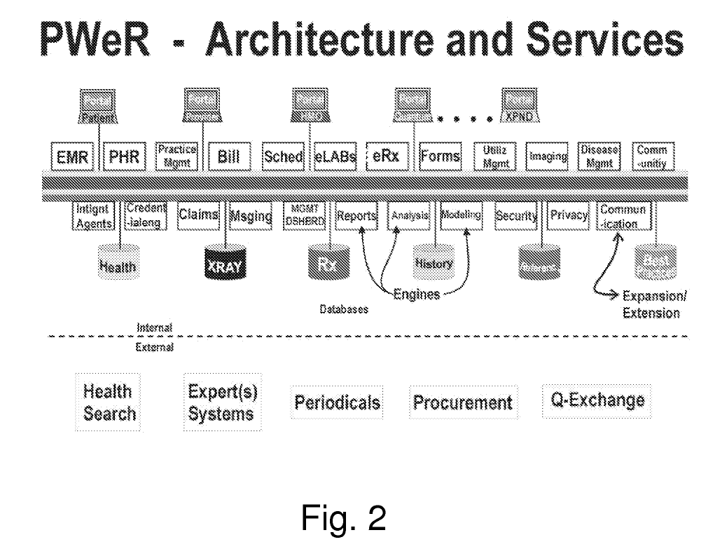

Referring now to FIG. 2, various portals (patient, provider, HMO, Quantum (the sponsor in this example), and possibly others, are clients. Databases of health, x-ray, prescriptions, history of keeping appointments, best practices, and the like are connected to the processor which includes modules for intelligent agents, credentialing, claims, messaging, system management, reports, analysis, modeling, security, privacy, and communication.

The system of the invention provides a unique and integrated technology and method addressing a major and costly component of the healthcare industry. The combination of innovative technology and the service it will provide create a new platform for efficiency, quality and cost reduction in an industry demanding all three. The invention creates financial opportunities for both parties, i.e., patient and provider, and increases effectiveness for trade and optimizes commerce.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A data processing system for assigning patients to providers of medical services and/or equipment comprising a database of providers of medical services, equipment, and instrumentation for patients, the database comprising records which comprise provider, medical service, medical equipment, instrumentation, location, and time slot data, means to receive a request for a medical procedure for a first patient, means to select a provider of medical service, provider of medical equipment, or provider of instrumentation from a plurality of providers based on a plurality of factors, and means to return at least one time slot for the service, equipment, or instrumentation in response to the request.

2. The system of claim 1 wherein the providers of medical services and/or equipment comprise providers of procedures using medical instrumentation selected from the group consisting of CAT scan, PET scan, sonogram, open MRI, closed MRI, dialysis, diathermy, prosthetics instrument, and genetically engineered structures, and the records are dynamically updated with current available time slots of each provider for each procedure using each medical instrumentation.

3. The system of claim 1 wherein the providers of medical services and/or equipment comprise providers of durable medical equipment.

4. The system of claim 1 comprising means to directly bill a patient or an insurer of a patient for a diagnostic procedure and medical equipment usage provided by an assigned provider.

5. The system of claim 1 further including means to calculate trends regarding diagnostic procedures requested and assigned and/or to predict conditions of care and requirements for supporting technology and services.

6. The system of claim 1 further including means to calculate trends regarding diagnostic procedures requested and assigned and/or to predict conditions of care and requirements for supporting technology and services wherein data regarding previous usage, pricing, missed appointments, insurance coverage, and/or payments is processed by the means to calculate the trends.

7. The system of claim 1 adapted to triage the assignment of patients to providers of medical services and/or equipment during periods of disaster or national emergency.

8. The system of claim 1 comprising means to schedule a medical procedure upon receipt of a selection from a client from a plurality of time slots returned for the specific instrumentation for the medical procedure in response to the client request.

9. The system of claim 1 further including means to price a medical procedure or equipment time based on temporal proximity between the request and the available time slots or geographical proximity between the client and the provider of services, diagnostic equipment, or durable medical equipment.

10. The system of claim 1 including means to chose between alternative treatments with respective time and equipment requirements, the alternative treatments yielding equivalent benefits.

11. The system of claim 1, where the defined algorithms for optimization of exchange define a marketplace for trade of medical commodities selected from the group consisting of equipment, skills availability time slots, services, provisions, and durable medical equipment and other components of medical enterprise.

12. The system of claim 1, where the defined algorithms for optimization of exchange define a marketplace for trade of components of medical enterprise.
